(19) United States
(12) Patent Application Publication
(10) Pub. No.: US 2009/0220711 A1
(43) Pub. Date: Sep. 3, 2009

(54) Bio-degradable cup and method for making the same

(76) Inventor: Hsi-Ching Chang, Taichung (TW)

Correspondence Address: HSI-CHING CHANG, P.O.BOX 215, TAICHUNG, 40099, TW

(21) Appl. No.: 12/230,722

(22) Filed: Sep. 4, 2008

(30) Foreign Application Priority Data
Feb. 29, 2008 (TW) 097107182

(51) Int. Cl. B32B 1/02; B32B 38/00

(52) U.S. Cl. 428/34.2; 156/218

(57) ABSTRACT

A bio-degradable cup includes an IXPE foam cup and a paper cup which is securely received in the foam cup. The paper cup includes a bio-degradable film coated to an inside thereof. The paper cup is made from a paperboard with a bio-degradable film coated and the paperboard is cut, folded and heat-pressed to be the paper cup. The foam cup is made from a foam board made by IXPE and the foam board is cut, shaped and folded into pieces and each piece is made to be the foam cup by way of heat pressing. A heat treatment is applied to an inside of the foam cup to obtain a sticky inner surface of the foam cup and the paper cup is securely connected to the sticky inner surface of the foam cup. A lip is made around an outer top edge of the foam cup.

### FIELD OF THE INVENTION

The present invention relates to a bio-degradable cup and a method for making the same.

### BACKGROUND OF THE INVENTION

A conventional bio-degradable cup generally includes a bottom with a peripheral wall extending from the bottom so as to enclose a cup with an open top. A water-proof layer is coated on a top surface of the bottom and the inside of the peripheral wall. A foam layer mounted to the outside of the peripheral wall. The water-proof layer and the foam layer are made by similar material and connected with each other by heat-fusion. The water-proof layer is composed of Polyethylene and Polypropylene, and the foam layer is composed of Polyethylene, Polypropylene and Polylactic Acid. The foam layer includes convex patterns formed on the outside thereof. The foam layer is made by a method which prepares melted plastic material and the melted plastic material is then injected to form the foam layer.

One way to connect the foam layer and the peripheral wall is that the foam layer is simply mounted to the peripheral wall, the foam layer is not well secured to the peripheral wall. The other way is that the water-proof layer is used as the adhesive layer for connecting the foam layer to the peripheral wall. However, the water-proof layer might not be spread evenly on the peripheral wall and the foam layer can be separated from the peripheral wall.

The present invention intends to provide a bio-degradable cup which includes a paper cup connected to inside of a foam cup which is made by IXPE and the paper cup is securely bounded to inside of the foam cup.

### SUMMARY OF THE INVENTION

The present invention relates to a bio-degradable cup which comprises a paper cup with a bio-degradable film coated to an inside thereof and an IXPE foam cup in which the paper cup is securely received.

The present invention further relates to a method for making a biodegradable cup and the method comprises the following steps:

a step of preparing a paperboard with a bio-degradable film coated on at least an inner or outer surface thereof, the paperboard being cut, folded and heat-pressed to be a paper cup;

a step of preparing a foam board made by IXPE, the foam board being cut, shaped and folded into pieces and each piece being made to be a foam cup by way of heat pressing;

a step of applying a heat treatment to an inside of the foam cup to obtain a sticky inner surface of the foam cup and the paper cup being securely connected to the sticky inner surface of the foam cup, and

a step of making a lip around an outer top edge of the foam cup.

The primary object of the present invention is to provide a cup suitable for receiving food and can be bio-degradable.

Another object of the present invention is to provide a method for making the bio-degradable cup.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows steps of the method for making the bio-degradable cup of the present invention;

FIG. 2 shows a foam pad is to be connected to an underside of the foam cup;

FIG. 3 is a cross sectional view to show the bio-degradable cup of the present invention;

FIG. 4 shows that the foam cup is made by the foam piece;

FIG. 5 shows another embodiment of the bio-degradable cup of the present invention, wherein the lip is separately made and then connected to the foam cup, and FIG. 6 shows a further embodiment of the bio-degradable cup of the present invention, wherein the top edge of the foam cup is located at ⅓ height from the bottom of the paper cup.

### DETAILED DESCRIPTION OF THE PREFERRED EMBODIMENT

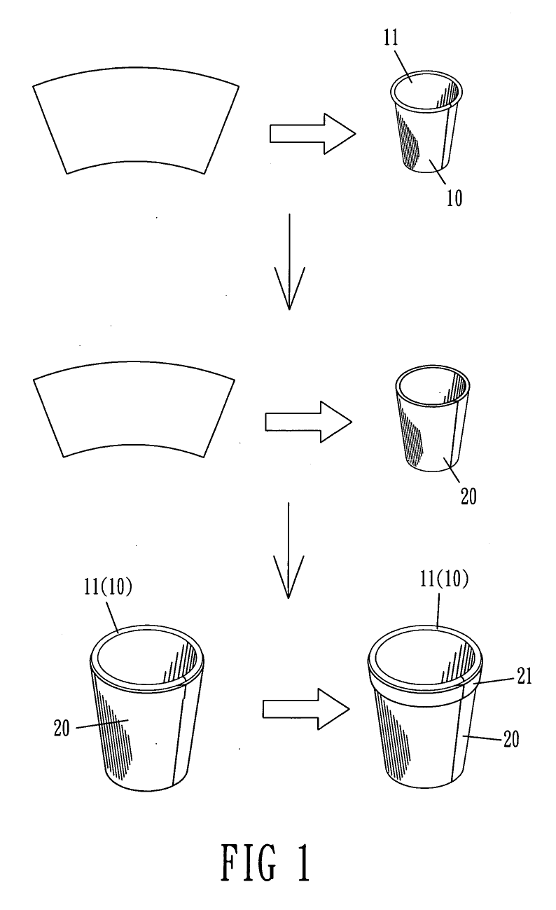

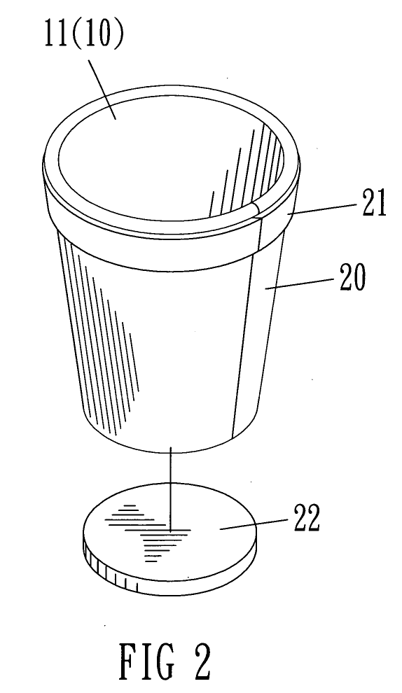

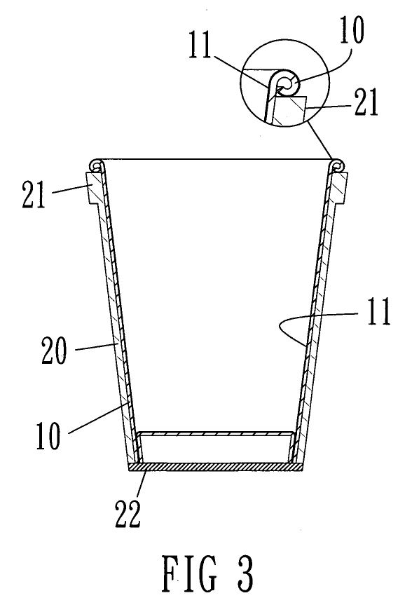

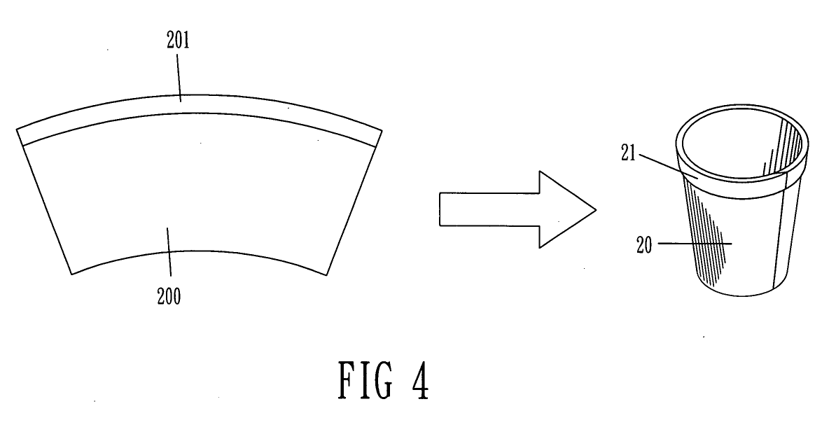

Referring to FIGS. 1-3, the method for making the bio-degradable cup of the present invention comprises a step of preparing a paperboard and a biodegradable film 11 being coated on at least inner or outer surface thereof, the paperboard then being cut and folded to be a paper cup 10. The bio-degradable film 11 is made by Plolylactic Acid (PLA) or any bio-degradable material, or by Polyethylene Terephthalate (PET), Polypropylene (PP), Polyethylene (PE).

A step of preparing a foam board 200 made by bio-degradable material or non-bio-degradable material. The bio-degradable material can be Plolylactic Acid (PLA), PHA, Bio-Polymers, bio-degradable plastic, Biomax PET, Fepol, Ecoflex, Mater-be by DuPond Company, or non-bio-degradable material such as Polyethylene Terephthalate (PET), Polypropylene (PP), Polyethylene (PE). The foam board 200 is made by IXPE and applied with a printing process, cutting, folding to be fan-shaped pieces which are then made to be foam cups 20 via necessary steps such as heat pressing or gluing.

A step of applying a heat treatment to an inside of the foam cup 20 to obtain a sticky inner surface of the foam cup 20 and the paper cup 10 securely connected to the sticky inner surface of the foam cup 20. The heat treatment can be any known ways such as hot-air heating, other known heat pressing, gluing to obtain a sticky or adhesive inner surface. The paper cup 10 is inserted into the foam cup 20 and a proper mold is used to securely connect the paper cup 10 to the foam cup 20.

A step of making a lip 21 around an outer top edge of the foam cup 20. During the pressing to connect the foam cup 20 and the paper cup 10, the lip 21 is formed on the outer top edge of the foam cup 20.

A step of connecting a foam pad 22 to an underside of the foam cup 20 and a diameter of the foam pad 22 being the same as an outer diameter of the foam cup 20. The foam pad 22 and the foam cup 20 are made by the same material and method.

As shown in FIG. 4, the lip 21 can be formed by pressing an outward portion along the top edge of each fan-shaped piece so that the outward portion 201 forms the lip 21 when the foam cup 20 is formed.

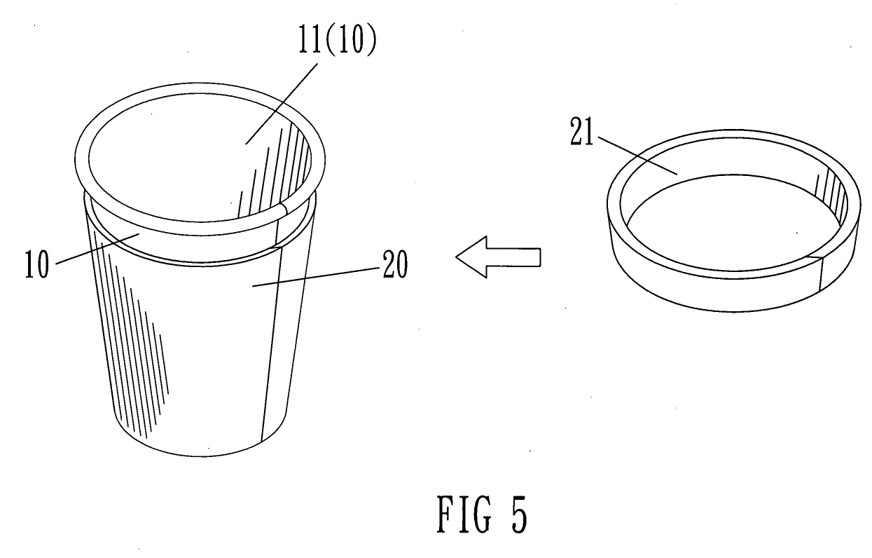

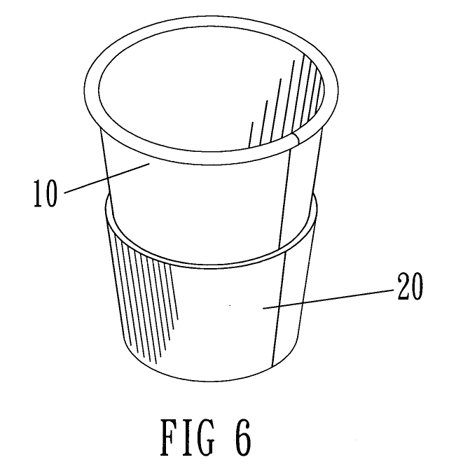

As shown in FIG. 5, the lip 21 can be made by another foam board which has different thickness from the foam board 200 to be made the foam cup 20, the lip 21 is securely connected to top edge of the foam cup 20. The paper cup 10 can be connected with the foam board 200 after or before the connection of the lip 21 and the foam cup 20.

As shown in FIGS. 1-5, the outward and curved lip on the paper cup 10 is rested on the lip 21 on the foam cup 20 when the bio-degradable cups are piles up. As shown in FIG. 6, the top edge of the foam cup 20 is located at about ½ to ⅓ height from the bottom of the paper cup 10. A lower edge of the foam cup 20 is in flush with a bottom of the paper cup.

The heat pressing for making the fan-shaped pieces to be foam cups 20 can be ultra-wave pressing, hot-air heating, ultra-wave pressing or electric heat pressing. A bio-degradable adhesive layer can also be spread on the inner surface of the foam cup 20 so as to connect the paper cup 10.

The foam cup 20 is made form the foam board 200 by way of cutting, folding to be fan-shaped pieces and heat pressing so that no injection molds needed.

The connection between the paper cup 10 and the foam cup 20 is by way of heat-fusion to obtain a sticky inner surface of the foam cup 20 so that the paper cup 10 is securely connected thereto. The IXPE foam cup 20 is water proof, oil proof and damp proof so that the bio-degradable cup of the present invention is an ideal cup for most of situations. Besides, the foam cup 20 has good isolation feature to heat and smooth outer surface, easily to be shaped and machined.

While we have shown and described the embodiment in accordance with the present invention, it should be clear to those skilled in the art that further embodiments may be made without departing from the scope of the present invention.

What is claimed is:

1. A method for making a bio-degradable cup, comprising:
a step of preparing a paperboard with a bio-degradable film coated on at least an inner or outer surface thereof, the paperboard then being cut, folded and heat-pressed to be a paper cup;
a step of preparing a foam board made by IXPE, the foam board being cut, shaped and folded into pieces and each piece being made to be a foam cup by way of heat pressing;
a step of applying a heat treatment to an inside of the foam cup to obtain a sticky inner surface of the foam cup and the paper cup being securely connected to the sticky inner surface of the foam cup, and
a step of making a lip around an outer top edge of the foam cup.

2. The method as claimed in claim 1 further comprising a step of connecting a foam pad to an underside of the foam cup and a diameter of the foam pad being the same as an outer diameter of the foam cup.

3. The method as claimed in claim 1, wherein the bio-degradable film is made by Plolylactic Acid (PLA), Polyethylene Terephthalate (PET), Polypropylene, or Polyethylene (PE).

4. The method as claimed in claim 1, wherein the foam cup is made by Plolylactic Acid (PLA), PHA, Polyethylene Terephthalate (PET), Polypropylene (PP), Polyethylene (PE), or Polystyrene.

5. The method as claimed in claim 1, wherein the lip on the foam cup is located beneath an outward and curved lip on the top edge of the paper cup.

6. The method as claimed in claim 1, wherein the top edge of the foam cup is located at ½ to ⅓ height from the bottom of the paper cup.

7. A bio-degradable cup comprising:
a paper cup with a bio-degradable film coated to an inside thereof;
a IXPE foam cup in which the paper cup is securely received.

8. The cup as claimed in claim 7, wherein the bio-degradable film is made by Plolylactic Acid (PLA), Polyethylene Terephthalate (PET), Polypropylene, or Polyethylene (PE).

9. The cup method as claimed in claim 7, wherein the foam cup is made by Plolylactic Acid (PLA), PHA, Polyethylene Terephthalate (PET), Polypropylene, Polyethylene (PE), or Polystyrene.

10. The method as claimed in claim 7, wherein a foam pad is connected to an underside of the foam cup.
